(19) United States
(12) Patent Application Publication
(10) Pub. No.: US 2008/0018944 A1
(43) Pub. Date: Jan. 24, 2008

(54) Image forming apparatus

(75) Inventor: Keisuke Morita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/826,306

(22) Filed: Jul. 13, 2007

(30) Foreign Application Priority Data
Jul. 20, 2006 (JP) JP2006-198202
May 23, 2007 (JP) JP2007-136631

(51) Int. Cl. H04N 1/21

(52) U.S. Cl. 358/296

(57) ABSTRACT

In the image forming apparatus 1, when the output sequence of each page is rearranged to be different from the input sequence of the image data of each page, the control section combines the image data and the stamp data after rearranging the output sequence.

This application is based on Japanese Patent Application No. 2006-198202 filed on Jul. 20, 2006, and No. 2007-136631 filed on May 23, 2007, in Japanese Patent Office, the entire content of which is hereby incorporated by reference.

### TECHNICAL FIELD

The present invention relates to a technology of combining image data and stamp data in an image forming apparatus that manages an output sequence of the image data read from an original document.

### TECHNICAL BACKGROUND OF THE INVENTION

Conventionally, an image forming apparatus has various functions associated with the management of the output image. For example, the page insertion function that adjusts a sequence of reading the document and the outputting, and a book copying function. Also a stamping function that identifies the date where the image data is out putted and the image forming apparatus.

The book copying function is that in case a document is a spread document, the left and right or above and below pages are scanned as one page and image data of the pages is divided into two pages respectively left and right or above or below, then the image data of each page is outputted to form an image on a sheet or is stored in a hard disk.

Further, the page insertion function is one in which after a document having a plurality of pages is sequentially read, a new document other than the document already read is read, then when the image data of the document is outputted, the newly read image data of the document is inserted between the pages of the image data of the document read first having a plurality of pages then the image data is outputted in this sequence where the page is inserted instead of the reading sequence.

Also, the stamp function is to combine stamp data such as a character string, for example, identification data of an image forming apparatus, a serial number that uses for a management number, date information indicating the date of output and image data. Further, for the serial number included in this stamp, the same number is not assigned within one image forming apparatus. The serial number is counted up every time the serial number is assigned. By setting the stamp function and by adding information to identify the image forming apparatus and the stamp including the serial number, the image forming apparatus, date and time of outputting can be specified.

Conventional example of a function to rearrange the output sequence of image data and reading sequence of the document, and image outputted by image forming apparatus having stamp function are described with reference to FIG. 9 and FIG. 10.

FIG. 9(A) is a diagram showing the reading sequence when the function of “two-page spread reading for front and back cover sheet” is set in the book copying function of the image forming apparatus. FIG. 9(B) is a diagram showing the conventional condition of the output image in which the stamp data and the image data of document are combined under these settings. Further, the serial number of the stamp in FIG. 9(B) is indicated by the numbers from “1001” to “1006”.

In order to set the book copying function so as to output a desired image, for example, an user sets the book copying function through a display operation section and the images of the document is read as shown in FIG. 9(A) in the sequence of “Front cover”, “Back cover”, “Document A, B” of a two-page spread, and “Document C, D” of a two-phage spread. Every time the document is read, stamp data for each page is created. At this time, the serial number included in the stamp created for each page is a sequential number which is the same as an order of reading the document. For example, when reading in the sequence shown in FIG. 9(A), the serial number is assigned in the same sequence.

After the stamp data for each page is created, the image data of the document and the stamp data are combined. The combined image is stored in the image memory of the image forming apparatus. Then the serial number is incremented for next assignment. By this increment, the same serial number cannot be assigned in the same image forming apparatus. Further, even if the job is completed, the serial number will not be reset, but will continue to be incremented and updated successively.

In this manner, the document is read and image data of each page is memorized successively in the image memory while the serial number is incremented and this process is repeated. For all documents, rearranging processing of the output sequence of the combined image data memorized in the image memory is carried out. This rearranging processing, for example, is carried out by rearranging the readout addresses affixed to the documents stored in the image memory.

In the output images shown in the example of FIG. 9(B), by setting the book copying function, the image data of the documents read at the third are stored as image data “Document A” and “Document B” on individual pages, and the image data of the documents read at the fourth are stored as image data “Document C” and “Document D” on individual pages in the image memory, and are then outputted. In addition, the serial number in the stamp function is assigned respectively to “Document A”, “Document B”, “Document C”, and “Document D” according to the sequence of reading at reading.

Further, in FIG. 9(B), because the “two-page spread reading for front and back cover sheet ” function is set in the book copying function of the image forming apparatus, the images are outputted in a sequence different from the sequence of reading in the images. When this “two-page spread reading for front and back cover sheet” function is set, although the image data outputted first is of “front cover sheet” in accordance with the reading sequence of the document, the image data of the document representing “rear cover sheet” read next is not outputted and image data outputted after “front cover sheet” is “Document A” which is read after “Rear cover sheet” and after “Document A”, “Document B” is outputted. In this example, “Rear cover sheet” is outputted after “Document D”, thus it is last in the output sequence of this job.

FIG. 10(A) is a diagram showing the reading sequence when “Page insertion after the first page of the document having 4 single sided pages” is set in the page insertion function. FIG. 10(B) is a diagram showing a conventional condition of an output sequence of image data in which the stamp data and the image data of the document data are combined under these settings. Further, in FIG. 10(B), the serial number of the stamp is indicated by the numbers “1234” to “1238”.

To output the desired images by setting the page insertion function, for example, after the document is read once, a user assigns arbitrary pages between which the new document is to be inserted through the display operation section, and the new document to be inserted is read in. For example, as shown in FIG. 10(A), after “Documents 1 to 4” are read, the user assigns a page after “Document 1”, because the insertion page is assigned between page 1 and page 2, then a new page “Document 5” is further read. Thereby “Document 5” is inserted after “Document 1”.

As aforementioned, the stamp data for each page is created every time a document is read, and is combined with the image data to be memorized in the image memory, therefore the serial number is a sequential number in the reading sequence. For example, when the combined data is read in the sequence of FIG. 10(A), the serial number is assigned in the same sequence as reading sequence of the document. Thereafter, the combined image data is outputted.

In the output images shown in the example of FIG. 10(B), since “Document 5” is inserted after “Document 1” by setting the insertion page function, the images are output in a sequence that is different from the sequence in which the images are read. In other words, although the output image to be outputted first is “Document 1” as per the sequence of reading in the document, the image data to be outputted next is not “Document 2” which is read after the “Document 1” but is “Document 5” which is read at last. Thus “Document 2” is outputted following “Document 5” and “Document 4” is outputted at last.

In this manner, conventionally, when the stamp function is set in the image forming apparatus, the timing of assigning the stamp data was at the time of reading in the documents. Therefore, if there was a change in the sequences of reading in the document and outputting the images, the sequence of the serial numbers added to output image by the stamp function was different from the output sequence.

For example, when the “two-page spread for front and back cover sheet” is set in the book copying function, as is shown in FIG. 9(B), since the reading sequence is “Front cover”, “Back cover”, “Document A and B”, and “Document C and D”, the serial numbers are assigned in that order as “1001”, “1002”, “1003” to “1006”. However, at the time of outputting the image data, since the output sequence of the image data is changed, the “Back cover sheet” that is read second is output last, thus the serial numbers of the output images will not be in sequence when the output image is observed in the output sequence.

Further, if the page insertion function is set, as is shown in FIG. 10(B), after reading “Document 1” to “Document 4” in a read in sequence, “Document 5” is read, and the serial numbers “1234” to “1237”, and “1238” are assigned in read in order. However, the image data of the documents is rearranged at the time of output and the “Document 5” that was read last is output second, thus, in this case, the serial numbers of the output images is also not in sequence when the output image is observed in the output sequence.

Meanwhile, conventionally, there have been an image forming apparatuses having the annotation functions which are adding page numbers, date, numbers allocated every time a document is set, or a background pattern. There has been propose an image forming apparatus having this annotation function, in which the page number is incremented for each image forming cycle, and page numbers, which do not exist in the original document, can be added (Patent Document 1).

Further, there has been suggested an image forming apparatus wherein annotation function is set to be disable or enable, arbitrary page to which the page number is added by the annotation function is inputted, and an user assigns a page where the page number is added, thereby the page number is combined with the image data and the combined image is outputted only for the arbitrary page assigned by the user.

Patent Document 1: Japanese Unexamined Patent Application Publication No. Sho 64-44972

Patent Document 2: Japanese Unexamined Patent Application Publication No. 2003-274151

As explained above, although the conventional annotation function where the stamp data is added to the document data has been proposed, in these methods of adding the stamp, in case the combining sequences in which the stamp data and the image data are combined is changed, namely in case “two-page spread reading for front and back cover sheet” is set in the book copying function, or in case the page insertion function is set, there can be a problem.

In other words, as the output images shown in FIG. 9(B) or FIG. 10(B) described above, when the output images are observed in the output sequence, the serial numbers assigned to the output images is not sequential, and there is occurs a discrepancy in which the sequence of the serial numbers is reversed in respect to the output sequence, which can confuse the user. For example, when the user reads the output images in the output sequence while referring to the stamp, if the serial numbers are not sequential, it is difficult to judge whether there is any change in the order of the serial numbers or whether there is any change in the output order. In addition, in case the images data added with stamps data is transmitted by an IP scanner, when the user carries out the input operation of the document related to the output images, if a reader is different from the user receiving and reading those output images, the reader confuses because it is difficult for the reader to recognize the shift between output sequence and serial number and the reader is confused.

In Patent Documents 1 and 2, the above problems are not disclosed and it is difficult to solve the confusion caused to the user as above with the annotation functions of the image forming apparatuses described in these Patent Documents.

### SUMMARY OF THE INVENTION

The present invention is made in view of the above problems, and the purpose of the present invention is to provide a technology that makes sure that there is no displayed discrepancy between the sequence of the serial numbers included in the stamp data and the output sequence of the image data to be outputted, even when the output sequence of the corresponding images data is different because the combining sequence of the image data of the document and the stamp data is different from the input sequence of the image data of the document.

The following structure solves the above problems: (1) An image forming apparatus where an image is formed based on the image data inputted for each page having:

a display operation section to set the output sequence of each page different from output sequence of the image data of each page;

a stamp forming section to form stamp data having a serial number which is serially assigned in an output sequence of the image data of each page and information which at least defines the image forming apparatus itself; and

a control section for carrying out combining processing to combine the image data and the stamp data as well as carrying out rearranging processing to rearrange the output sequence of the image data of each page;

wherein the control section carries out the combining processing after rearranging the output sequence.

### BRIEF DESCRIPTION OF THE DRAWINGS

FIG. 1 is a schematic configuration diagram of an image forming apparatus related to an embodiment of the present invention.

FIG. 2 is a block diagram showing the schematic configuration of control of the image forming apparatus related to an embodiment of the present invention.

FIG. 3 is a diagram showing a settings screen for making the settings related to page editing of the output images in an image forming apparatus related to the embodiment of the present invention.

FIG. 4 is a setting screen for the settings related to the book copying function, in the page editing functions of the output image in an image forming apparatus related to the embodiment of the present invention.

FIG. 5 is a setting screen for the settings related to the page insertion function, in the page editing functions of the output image in an image forming apparatus related to the present preferred embodiment of the present invention.

FIG. 6(A) is a diagram showing the input sequence of the documents inputted in an image forming apparatus related to the embodiment of the present invention. FIG. 6(B) is a diagram showing the condition in which stamp data is combined and the output sequence of the combined image data is rearranged, in case the “two-page spread reading for front and back cover sheet” function is set for the book copying function in an image forming apparatus according to the present preferred embodiment of the present invention.

FIG. 7(A) is a diagram showing the input sequence of the documents inputted in an image forming apparatus related to the embodiment of the present invention.

FIG. 7(B) is a diagram showing a condition in which the stamp data is combined and the output sequence of the combined image data is rearranged, in case page insertion function is set.

FIG. 8 is a flow chart in case the output sequence of the image data is rearranged by a book copying function or by a page insertion function in an image forming apparatus related to the embodiment of the present invention.

FIG. 9(A) is a diagram showing the reading in sequence when the “two-page spread reading for front and back cover sheet” function is set for the book copying function in an image forming apparatus.

FIG. 9(B) is a diagram showing the conventional condition of the output sequence of the image data in which the stamp data and the image data of the document is combined when the “two-page spread reading for front and back cover sheet” function is set for the book copying function in an image forming apparatus.

FIG. 10(A) is a diagram showing the read-in sequence of the documents when the setting “Insert a page after the first page of a document having 4 single sided pages”.

FIG. 10(B) is a diagram showing a conventional condition of output sequence of an image data in which the stamp data and the image data of the document is combined under a circumstance where “page insertion after first page of document having 4 single sided pages” is set in the page insertion function in an image forming apparatus.

### DETAILED DESCRIPTION OF THE PREFERRED EMBODIMENTS

### <Configuration>

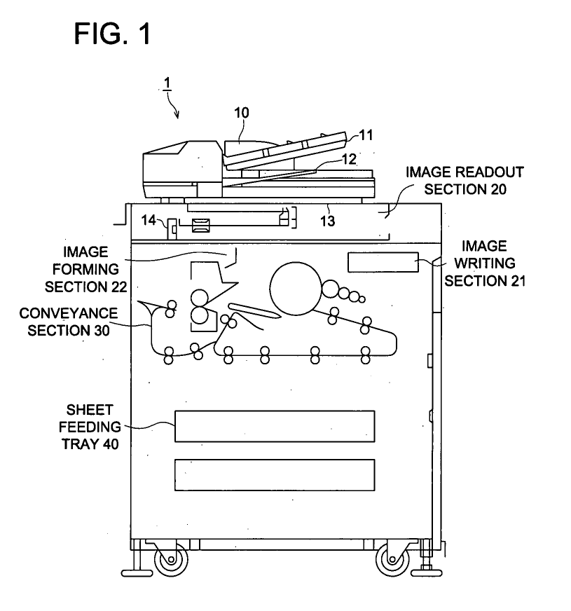

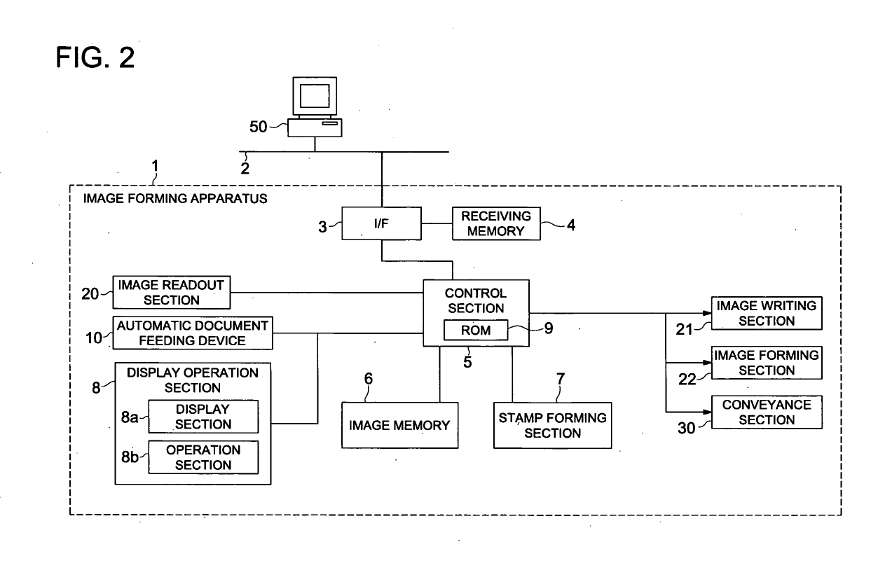

The configuration of an image forming apparatus 1 related to a preferred embodiment of the present invention is explained referring to FIG. 1 and FIG. 2. FIG. 1 is a schematic configuration diagram of an image forming apparatus 1 of the present invention. FIG. 2 is a block diagram showing the schematic configuration of control of the image forming apparatus 1 of the present invention.

The image forming apparatus 1 related to the embodiment is configured to have an ADF (Automatic Document Feeder) 10, an image read-in section 20, an image writing section 21, an image forming section 22, a conveying section 30, and one or more sheet feeding trays 40. The image forming apparatus 1, for example, reads-in the documents fed from the ADF 10 in the image reading section 20 and carries out image processing, and then forms the image on the sheet fed from a sheet feeding tray 40 by the image forming section 22. The sheet, on which the image is formed is conveyed by the conveying section 30. Meanwhile, the image forming method in the image forming apparatus 1 related to the embodiment is the widely known electro-photographic method. The configuration of each section of the image forming apparatus 1 are described below.

The automatic document feeding apparatus 10 has a document loading section 11 on which the document is placed, and when the document is loaded on it, it conveys said document to the image reading section 20. The document of which image is read by the image reading section 20 is discharges to the document discharge section 12.

The image reading section 20 reads the image of document that is conveyed from the automatic document feeding apparatus 10 or is placed on a document table 13 using a CCD (Charge Coupled Device). The image writing section 21 radiates laser light beam corresponding to the image data read onto a photoreceptor drum 23 thereby forming an electrostatic latent image, developing this electrostatic latent image, and forming a toner image on the photoreceptor drum 23.

On the other hand, recording sheets are conveyed by the conveying section 30 to the image forming section 22 from the sheet feeding trays 40.

The image forming section 22 has a photoreceptor drum, and transfers the toner image formed on the photoreceptor drum. When said toner image is transferred onto the sheet, the sheet is separated from the photoreceptor drum, and said toner image is fixed on the sheet by applying pressure and heat. In the case of double-sided printing, an image is formed also on the other surface of said sheet. The sheet on which image formation is made is discharged form the image forming apparatus 1.

Next, using FIG. 2, the schematic configuration of the control section for the image forming apparatus 1 related to the embodiment are described.

As is shown in FIG. 2, the image forming apparatus 1 has, automatic document feeding apparatus 10 and the image forming section 22, an I/F (Interface) 3, an image memory 4, a control section 5, an image memory 6, an optional stamp generating section 7, a display operation section 8.

The control section 5 is configured to include a microprocessor such as a CPU (Central Processing Unit), a RAM (Random Access Memory) and a ROM (Read Only Memory) etc. In addition, control programs are stored in advance in ROM 9, and the CPU loads said control programs into the RAM. Thus it functions as control section 5. Specifically, it carries reading control, read address control, transmission and reception control, display operation control, image processing control, rearrangement processing to rearrange read-out address, stamp data combining processing, and printer control. Each of the processes and controls are described later. In addition, ROM 9 also stores display screen data that is displayed in the display section 8a of display operation section 8 in advance.

Image data transmitted from an external terminal 50, and received by the I/F 3 via the network 2, is temporally stored in memory 4. The network 2 can be, for example, a LAN (Local Area Network), etc.

The temporally stored image data is subjected to image processing, and is transmitted to the image memory 6 by the transmission and reception control to be described. The image memory 6 stores the image data received from the receiving memory 4 and the image data read out through the image reading section 20.

The stamp data creation section 7 is configured to have an internal clock for managing the date information, and a counter for counting the serial number. Also, the stamp data creation section 7 stores in advance the identification information of the image forming apparatus, and manages the serial number used for the management number, etc., and the date information that indicates the output date. Among these, the serial number is incremented and updated every time it is added to the image data. Stamp creation section 7 creates the stamp data having these items of information, according to the settings made via the display operation section 8. Meanwhile, the information managed by the internal clock can also be the date and time information.

The display operation section 8 is configured to have a display section 8a and an operation section 8b. For this display section 8a, for example, an arbitrary display device such as an LCD (Liquid Crystal Display) can be used. The operation section 8b is configured including an arbitrary input device and an operation device such as operation buttons, ten keys, light pen, etc. Meanwhile, the display section 8a and the operation 8b need not be provided separately, but they can be integrated such as, for example, a touch panel type LCD display, etc.

Here, each process and control of the control section 5 in an image forming apparatus 1 related to the embodiment are explained below.

In the read-in control by the control section 5, the automatic document feeding apparatus 10 is controlled to convey the document loaded in it or the document placed on the document table is conveyed to the image reading section 20, and the image of the document is read out by the image reading section 20.

In the transmission and reception control by the control section 5, when there is an input of image data from the image reading section 20 or from the network 2, the image data is received as a job and is accepted in input sequence of pages of the image data. When the job is received from the network 2, the image data input via the I/F 3 is stored in the receiving memory 4 temporally. The image data temporally stored in receiving memory 4 is image-processed and transmitted to image memory 6. On the other hand, when the job is received from the image reading section 20 based on the read-out control, read-out address is given to the image data related to the job and is controlled to be memorized in the input sequence of page in image memory 6. Further, according to the instructions from the display operation section, the control is carried out transmission of the image data to an external device via the network 2.

In the read-out address control by the control section 5, for each page of the image data received via the I/F 3 or from the image reading section 20, the read out address is allocated in the input sequence. The image data corresponding to this allocated address is memorized in the image storage device 6. Next, a list of read-out addresses is made and the image data is controlled using the list. Also, this read- out address is used, when the stamp data combining process to be described later, is carried out, for read-out the image data from the image memory 6, and, when outputting the image data in which the stamp data is combined, this is also used for reading-out the combined image data.

In the display operation control by the control section 5, the display screen, in which the user sets details related to the job regarding the documents to be input, is displayed in the display section 8a of the display operation section 8. The details related to jobs are, for example, the details related to the sheets for the output image data (enlargement or reduction ratio, sheet orientation, size of sheets, and heet feeding tray, etc.), the details related to the output sequence of the job (book copy function, page and inserting function), details related to output (number of sheets, sheet discharging ray, sheet discharging mode, sorting, separating, presence or absence of transmission to IP scanner and transmission destination, etc.), details related to bookbinding (position of stitching and type of printing, etc.), and the details related to the stamp (date information, image forming apparatus identification information and serial number, etc.).

As an example of the settings of details related to the job, etc., set by the user, there is the setting of the book copying function or the setting of the page insertion function. For example, in the display screen displayed in the display section 8a, the user can make these settings using the operation section 8b. Further, these settings are normally made before carrying out the operations of inputting the document data.

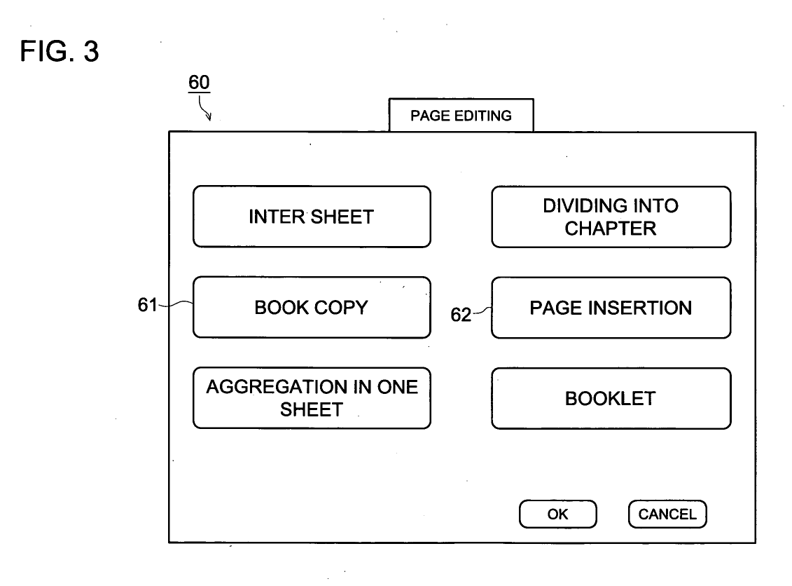

Here, the method of setting the book copying function or the page insertion function is described below with reference to FIG. 3 to FIG. 5. FIG. 3 is a diagram showing the settings screen for making the settings related to page editing of the output images in an image forming apparatus 1 related to the embodiment of the present invention.

As is shown in FIG. 3, the page editing of the output images in the present embodiment is set by the user to press any editing function button (book copying function button 61, etc.) in the list of editing functions screen 60 through the operation section 8b, and then the detailed settings is made in each editing function setting screen. In other words, when an editing function button is selected by the user, the control section 5 reads-out the screen data of the editing function corresponding to the selected button (for example, the book copying settings screen 70, etc.,) from ROM 9 and displays it in the display section 8a.

For example, when using the book copying function as the page editing function of the output images, the book copying function button 61 is selected through the operation section 8b, and the detailed settings for the book copying are made. When using the page insertion function, the page insertion function button 62 is selected, and the settings are made in the page insertion setting screen. Further, in the present embodiment, the operation of the editing functions list screen 60 is carried out using the display section 8a and the operation section 8b.

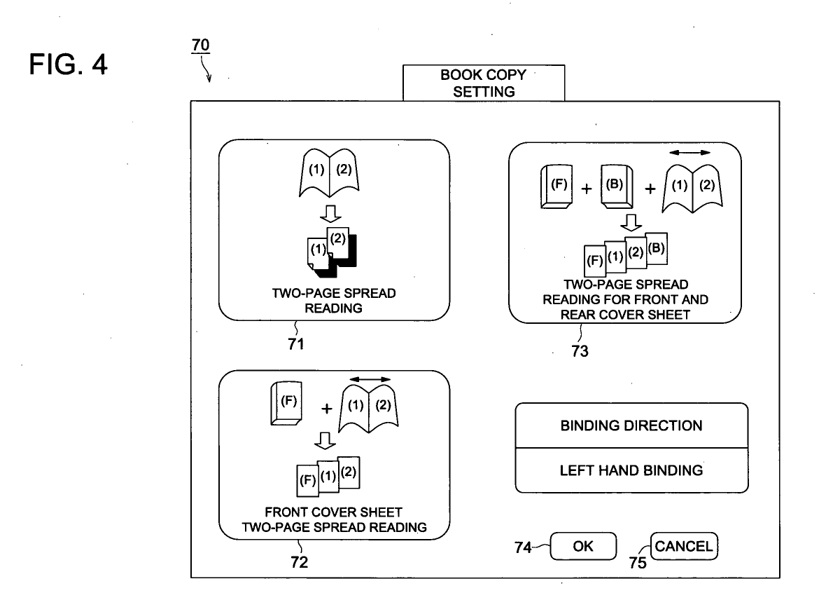

FIG. 4 is a settings screen of the settings related to the book copying function, among the page editing functions of the output image in an image forming apparatus 1 related to the embodiment of the present invention. The user can select the book copying function corresponding to each button by selecting any one of the “Two-page spread reading button” 71, the “two-page spread reading for front and back cover sheet button” 72, or the “two-page spread read button reading for front and back cover sheet button” 73.

To confirm any one of the selected book copying functions, the user selects the OK button 74 through the operation section 8b. When any book copying function is selected and the OK button 74 is pressed, the control section 5 stores the corresponding selected conditions into ROM 9 as the control signals. In these control signals, the output sequence of the page of the job for the documents is included. Further, when canceling the book copying function, select the Cancel button 75. When the cancel button 75 is selected, the control section 5 reads-out the screen data of the editing functions list screen 60 from ROM 9 and displays it in the display section 8a.

Here, “Two-page spread reading” is the function by which the image forming apparatus 1 accepts input of a two-page spread document, and the two-page spread document inputted is divided into two pages i.e. left and right or top and bottom pages, and these are respectively output as separate pages. Further, the “two-page spread reading for front and back cover sheet” function is a function of rearranging the output page sequence wherein when the “Back cover” is input second in a single job, “Back cover” is output last in the page output sequence of the job of the two-page spread document. The “two-page spread reading” here is the same as that described earlier. However, in this, book copying function, while the “Front cover sheet” and the “Back cover sheet” are inputted first and second, “Front cover sheet” and the “Back cover sheet” are outputted without being divided.

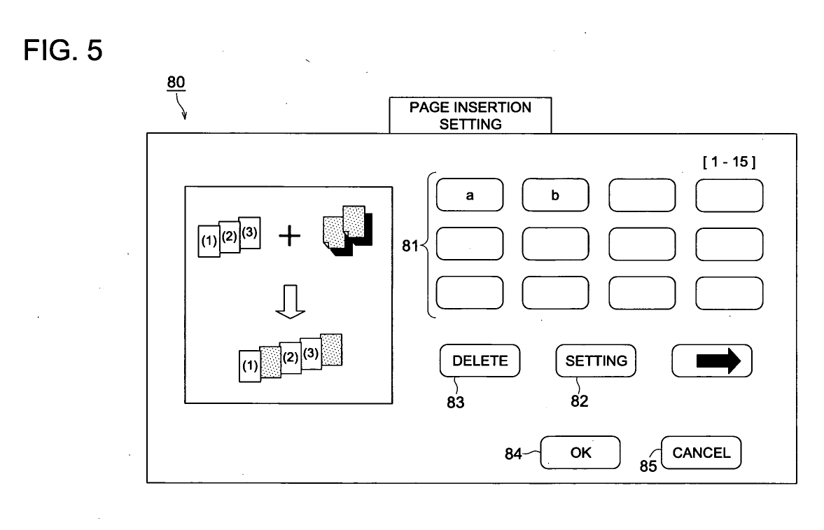

Further, FIG. 5 is a settings screen to set the page insertion function, among the page editing functions of the output image in an image forming apparatus 1 related to the embodiment of the present invention. The settings of the page insertion function in the embodiment are made in the page insertion setting screen. In the page insertion assigning area 81a and 81b of page insertion screen 80, a page in front of the insertion pages is inputted. For example, in case a new document is inserted between the first page and the second page, the first page which is in front of the insertion document is inputted. This input is made using the operation section 8b. When using a touch panel type LCD, the selection is made using the page insertion assigning area 81a and 81b, etc., which are in the form of software keys, and the number of pages to be inserted is inputted through the ten keys.

The settings button 82 is selected for inputting insertion pages in the page insertion assigning area 81a and 81b and for setting the insertion pages so input. When the insertion pages are needed to be modified, the page insertion assigning area where the insertion pages to be modified are inputted is selected and then the delete button 83 is selected. When the setting of the insertion pages is completed, the OK button 84 is selected in the operation section 8b, thereby the insertion page function is confirmed.

In this manner, when any insertion page function is selected and then the OK button 84 is selected, the control section 5 transmits the conditions of the confirmed insertion page function as control signals and stores them in ROM 9. These control signals include the sequence of page output of the job related to the document. Further, the cancel button 85 is selected in case the insertion page function is cancelled. When the cancel button 85 is selected, the control section 5 reads-out the screen data of the editing functions list screen 60 and displays it in the display section 8a.

The insertion page function here means that after reading a document having a plurality of pages sequentially, a new document different from that read in advance is read, and at the time of outputting these documents data, the documents are not output in the sequence in which they were read-in, but the newly read image data of the document is inserted in between some desired pages among the plurality of pages of image data of the document read first, and the images data are output in that sequence.

Further, regarding the setting of the stamp, the user can carry out setting of combining stamp data and image data of the document in a screen displayed in the display section 8a, through operation section 8b. The control section 5 transmits the setting of executing stamp data combining as control signals and stores them in ROM 9.

In the above manner, the rearrangement processing of outputting sequence and the stamp data creation processing to be described are executed based on the control signals related to the conditions of page editing or related to the settings of the stamp data stored in ROM 9.

In the image processing control by the control section 5, compression processing or decompression processing is carried out for the image data of the document memorized in the receiving memory 4 or in the image memory 6, and image processing where the input or output document data is rotated is carried out, so that the function of generating the timing signals of the I/F 3 is carried out. In addition, the control of discharging the document which is read-in the image read-in section 20.

In the rearranging processing of outputting sequence by the control section 5, a judgment is made as to whether or not page output sequence rearrangement processing for the image data of the document stored in image memory 6 is to be carried out. In this judgment, whether or not the control signals related to the rearrangement processing of page outputting sequence for the aforesaid job is stored in ROM 9. In case, the control signals related to page rearrangement is stored in ROM 9, the page rearrangement processing described later is carried out based on the information related to the page sequence which is present in those control signals.

As a concrete method of this rearrangement processing, for example, it is possible that the output sequence of image data to be output is changed by rearranging readout address added to each page of image data of the document in a read-out address list made by address management function regarding the job.

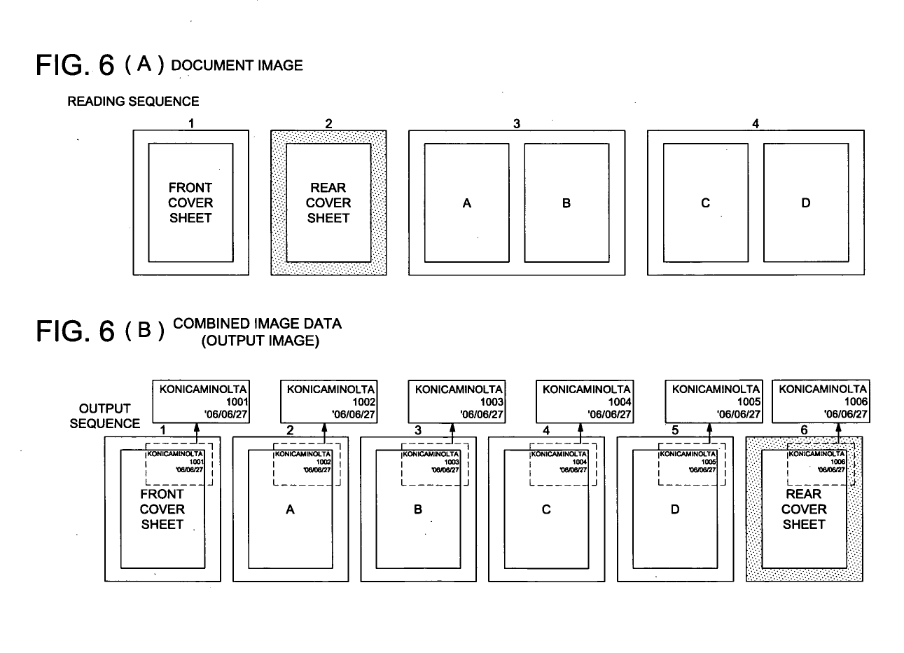

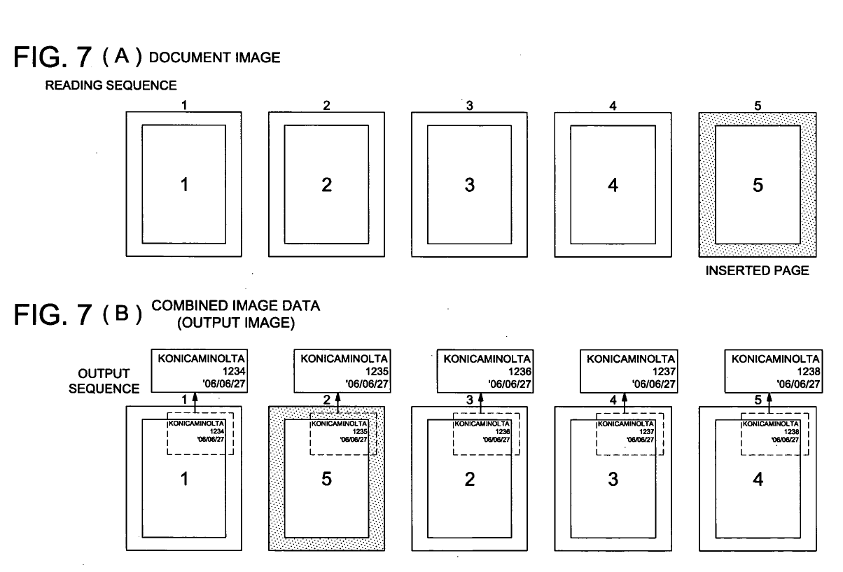

Further, the processing of rearranging the output sequence is executed in the cases, for example, when the “two-page spread reading for front and back cover sheet” function is set for the book copying function, when the insertion page function is set, or when some other inter-sheet function is set. Now, the condition in which the output sequence is rearranged is explained with referring to FIG. 6 and FIG. 7 for the cases when the “two-page spread reading for front and back cover sheet” setting is set for the book copying function, or when the insertion page function is set.

Further, FIG. 6(A) is a diagram showing the input sequence of the documents which are inputted in an image forming apparatus 1 related to the embodiment of the present invention. FIG. 6(B) is a diagram showing the condition in which stamp data is combined and the output sequence of the combined image data is rearranged for the case when the “two-page spread reading for front and back cover sheet” function is set for the book copying function in the image forming apparatus 1 related to the embodiment of the present invention. FIG. 7(A) is a diagram showing the input sequence of the documents in the image forming apparatus 1 related to the an embodiment of the present invention, and FIG. 7(B) is a diagram showing the condition in which the stamp data is combined and the output sequence of the combined image data is rearranged for the case when the setting “page insertion after first page of document having 4 single sided pages” is set in the insertion page function in image forming apparatus 1 related to the embodiment of the present invention.

When the “two-page spread reading for front and back cover sheet” function is set for the book copying function, as shown in FIG. 6(A), even in the case the sequence of reading in the document is “Front cover sheet”, “Back cover sheet”, “Document A, B” of a two-page spread, and “Document C, D” of a two-phage spread, as shown in FIG. 6(B), by the rearrangement processing of the output sequence of the control section 5, the out put sequence of the image data is rearranged so that the “Back cover sheet” is output last.

Further, when the insertion page function has been set, as is shown in FIG. 7(A), even when the sequence of reading the document is “Documents 1 to 4”, then “Document 5”, as shown in FIG. 7(B), by the rearrangement processing of output sequence of the control section 5, the output sequence of the image data is rearranged so that the “Document 5” is output as the second page, and the output sequence of “Documents 2 to 4” shifts by the amount of inserting “Document 5”.

In the stamp data processing by the control section 5, if the control signals indicating that the stamp data related to the job is to be combined is stored in ROM 9, the stamp data creation section 7 creates the stamp data based on those control signals. This stamp data is created for each page of the image data. This stamp data creation processing is carried out after the rearrangement processing when the rearrangement processing is executed. In addition, when adding a serial number to each page of the image data as stamp data, every time the serial number is added, a counter is incremented one by one and this increment updates the serial number for the next image data to which the stamp is added.

In the stamp data combining processing by the control section 5, the stamp data created for each page of the image data is combined with the corresponding image data. This combining processing is, for example, as shown in FIG. 6(B) and FIG. 7(B), to add the stamp data to the image data and to create a successive image data.

Further, in the stamp data combining processing, the image data in which the optional stamp and the image data are combined is stored in image memory 6. In addition, when the combined image data is stored in the image memory 6, it is registered in the read-out address list that combined image data is combined with the stamp data using the read-out address added to the combined image data,

In the printer control, a job related to the inputted image data of the document is carried out and combined image data stored in image memory 6 is output to the sheet for forming an image by controlling the image writing section 21, the image forming section 22, the conveying section 30, and the sheet feeding trays 40.

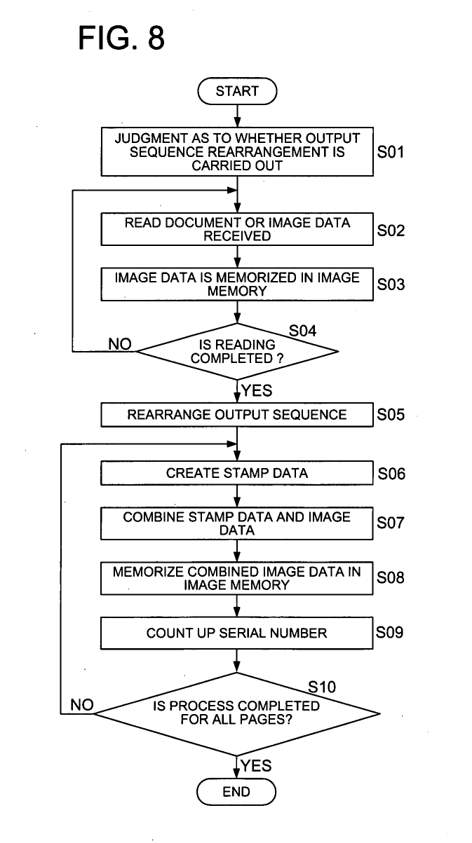

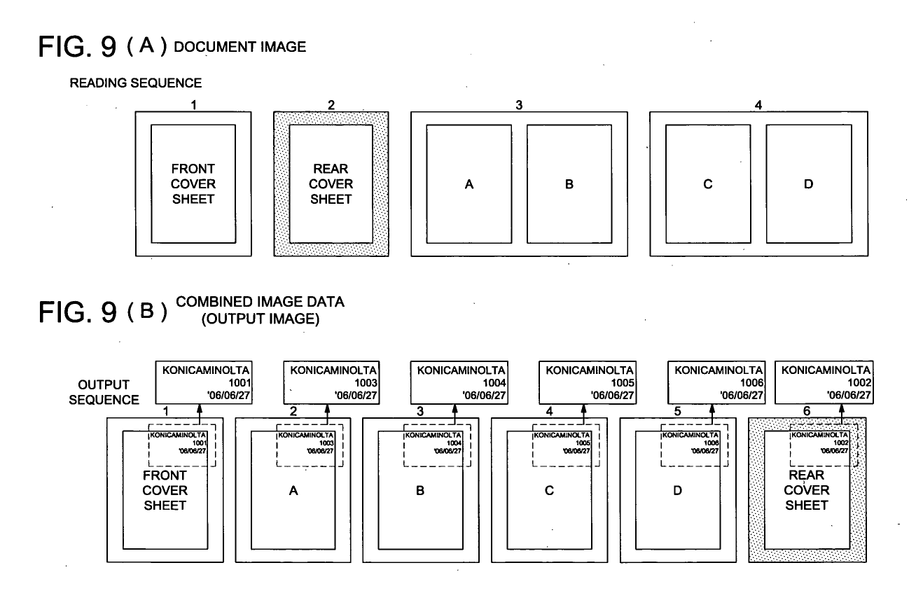

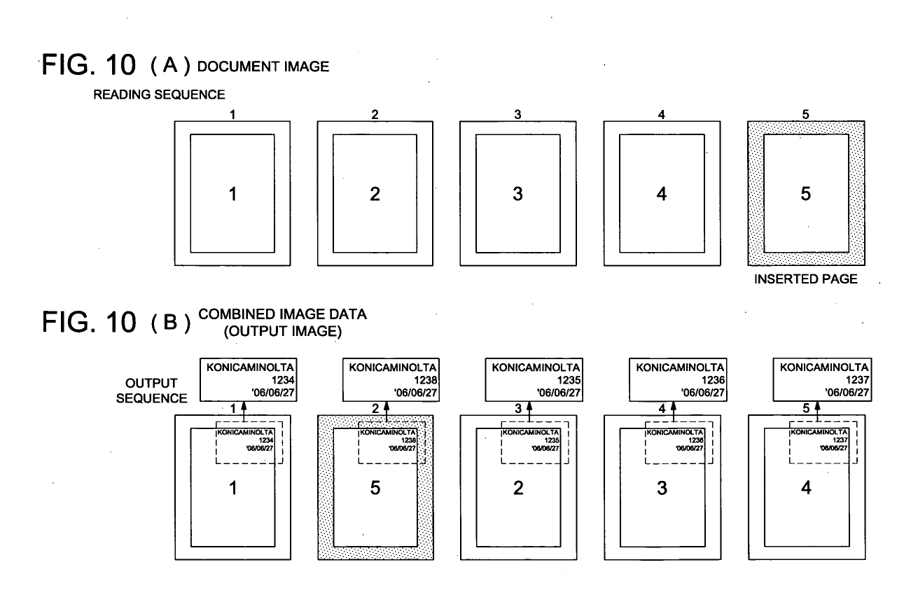

Next, using FIG. 6 to FIG. 8, a successive operation in the image forming apparatus 1 related to the embodiment is described from receiving the input of documents, the processing of combining of the document image with the stamp data, to outputting the image data. FIG. 8 is a flow chart showing the successive operation when the rearranging process of the output sequence of the image data is carried out by the book copying function or by the page insertion function in an image forming apparatus related to the embodiment of the present invention.

### (S01)

Control section 5 stores the conditions set in ROM 9 in case conditions related to the job for the document is set. At this time, based on the conditions stored in ROM 9, a judgment is made as to whether or not the aforesaid rearrangement process of image data outputting sequence is to be carried out.

### (S02)

When a job related to an image data of a document is accepted and the image data of the document is inputted, the control section 5 starts processing the job related to the image data of the document based on the set conditions of the image data of the document which is set by the display operation control when a job related to an image data of a document is accepted and the image data of the document data is inputted. At this time, the processing is started with the conditions set beforehand in case no setting have been made by the display operation section. The processing here means managing of the read-out addresses and so forth.

### (S03)

When the processing of the job related to the image data of the document starts, the control section 5 carries out compression processing on the image data of the document inputted and stores it in the image memory 6. Further, when the image data of the document is inputted by reading the document placed on automatic document feeding device 10 or on the document table 13, the image is stored in image memory 6, and the image data inputted from an external apparatus such as an external terminal 50, etc., is first stored in the receiving memory 4 and is then stored in the image memory 6.

### (S04)

Control section 5 judges whether the reading of all the documents is completed for the job referring to the set conditions for the job related to that document stored in S01 and the number of pages in the job related to the documents accepted in S02.

If it is judged that the reading of documents is not completed (S04: NO), the operation in S02 of inputting the image of the document is continued.

### (S05)

When, the control section 5 judges that the reading of the image of the documents is completed (S04: YES) in S04, the output sequence of the image data of document stored in the image memory 6 is rearranged by changing the read-out address added to each page in the read-out addresses list. This rearrangement is carried out based on the information related to the output sequence of image data of each page in the conditions stored in the RAM in S01. For example, as shown in FIG. 7, the insertion of an insertion page is executed based on the conditions set in the insertion page function.

### (S06)

The control section 5 creates the stamps data for each of the pages of the rearranged image data when the rearrangement processing for output sequence of the image data is executed in S05 and the rearrangement processing is completed. This stamp data is created based on set conditions stored in the RAM in S01. In this manner, by carrying out the creation of the stamp data after the rearrangement processing of output sequence of the image data, even in case the rearrangement processing of output sequence of image data is made, the serial numbers of the stamp will be output as sequential numbers without having contradiction of the output sequence. For example, even when the “two-page spread reading for front and back cover sheet” function is set in the book copying function, as shown in FIG. 6(B), the serial numbers are output as sequential numbers “1001”, “1002”, “1003” to “1006” in a rearranged output sequence. In addition, even when the insertion page function is set, as shown in FIG. 7(B), the serial numbers are assigned in the rearranged output sequence and are output as serial numbers.

### (S07)

After control section 5 executes and completes creation processing of the stamp data in S06, the control section 5 combines the stamps data created for each page with the image data in the sequence of the image data where the output sequence is rearranged in the read-out list in S05. In this manner, an image data becomes the combined image data where the image data and the stamp data combined, which is actually output.

### (S08)

The control section 5 stores the combined image data in which the stamp data combining processing in S07 is carried out, in the image memory 6. At this time, the sequence of the pages of the image data stored becomes the sequence of the list of read-out addresses which is rearranged by the output sequence rearrangement processing.

### (S09)

Every time a serial number is added to each page of the image data as the stamp data in S07, the control section 5 increments the serial number of the counter in the stamp data creation section 7 by 1, and updates the serial number stored in the stamp data creation section 7 by the incremented value.

### (S10)

When the serial number stored in the stamp data creation section 7 is updated, the control section 5 makes a judgment as to whether the combining of the stamp data is completed for all pages of the image data in the job related to the document. This judgment is made by judging whether the image data for each read-out address is registered as “processed” based on the list of read-out addresses prepared in the image memory 6 by the read-out address management function.

If it is judged that the combining of stamp data is not completed (S10: NO), the stamp data combining is continued again from S06. On the other hand, if it is judged that the combining of stamp data is already completed (S10: YES), the control section 5 executes the job related to the document, and controls the image writing section 21, the image forming section 22, the conveying section 30, and the sheet feeding trays 40, and then outputs the combined image data stored the image memory 6 according to the method set in display operation, namely forming an image on a sheet or outputting an image via IP scanner transmission.

### OPERATION AND EFFECT

The operation and effect of the image forming apparatus related to the present embodiment described above are explained hereunder.

The image forming apparatus related to the embodiment of the present invention sets the output sequence different from the input sequence of the image data of the document through control section 5. Further in case of “two-page spread reading for front and back cover sheet” function of the book copying function or page insertion function which requires rearrangement processing of the output sequence, stamp data and image data of the document for each page are combined after the output sequence is changed.

Therefore, even when the stamp data function is set and the rearrangement processing of output sequence is executed, it is possible to make the serial number added to the image data of the document into the sequential number which is in the sequence of output. As the result, it prevents that the output sequence and the serial number are reversed between pages of the job, and a contradiction between the output sequence and stamp. Thus it can avoid confusion of user.

### MODIFIED EXAMPLE

Next, a modified example of an image forming apparatus related to the present invention is explained hereunder.

In the image forming apparatus 1 according to the embodiment described above, although it is configured that a sequential serial number, the date information or the identification information of image forming apparatus are combined together as a function to identify the image outputted, the present invention shall not be construed to be limited to this embodiment. For example, it is also possible to combine page numbers, standard format stamps, and watermarks that are added to the output image, and it is further possible to combine text information such as “Confidential”, “Circular”, “Recover”, “Copy Prohibited”, “Urgent”, etc., as the stamp data with image data of the document, thereby making it possible to eliminate the work of affixing these text information by manual operations.

Further, although the image forming apparatus 1 related to the embodiment is configured to have a plurality of input sections (I/F 3, image reading section 20, etc.,) and a plurality of output sections (I/F 3, image forming section 22, etc.,), the present invention shall not be construed to be limited to this embodiment, and it is possible that only one input section is provided, and similarly, it is possible that only one output section is provided. In this modified example, by preventing a contradiction between the output sequence and stamp, the user can avoid confusion.

Further, although the image forming apparatus 1 related to the embodiment is configured that in the rearrangement processing of output sequence by the control section 5, the rearrangement of the output sequence is executed by rearranging the read-out address affixed to each image data in the list of read- out addresses, the present invention shall not be construed to be limited to this embodiment and it is possible to configure that the image data per se is rearranged. For example, it can be configured that in image memory, the image data of the document can be managed by the list, and control section 5 rearranges the image data of the document in the list. In this modified example, similar to the image forming apparatus 1 related to the embodiment described above, it is possible to avoid confusion of the user by preventing any contradiction between the output sequence and the stamps.

According to the embodiments, the configuration is such that after the sequence of the pages is rearranged by the output sequence adjusting section, said page and the stamp data are combined, and the combined image data is then output. Therefore, even if the output sequence of the images data is different from the input sequence of the document, the serial numbers are not assigned in the input sequence of the document, but because the stamp data are added to the image data which is rearranged in the output sequence set, it is possible to assign the sequential serial numbers to the output image data in the output sequence, and to prevent a shift between the output sequence and the serial numbers. As a result, it is possible to avoid the confusion for the users of the output sequence rearranging function in the image forming apparatus.

What is claimed is:

1. An image forming apparatus to form an image based on image data of a document inputted page by page comprising:
a display operation section to assign an output sequence of each page to be different from an input sequence of image data of each page;
a stamp forming section to form stamp data having information to identify at least the image forming apparatus, and a serial number which is given serially in the output sequence of the image data of each page; and
a control section to implement rearranging process which rearranges the output sequence of the image data of each page to be an output sequence assigned in the display operation section, as well as to implement combining process which combines the image data and the stamp data inputted;
wherein the control section implements the rearranging process of the output sequence, and thereafter implements the combining process.

2. The image forming apparatus of claim 1, further comprising:
an image memory to memorize the image data inputted;
wherein a readout address is affixed to the image data to be retrieved from the image memory, and wherein the control section rearranges the readout address affixed to the image data corresponding to the output sequence assigned in the display operation section so as to rearrange the output sequence of the image data.

3. The image forming apparatus of claim 1, wherein in case the document is a two-page spread document, the control section divides the image data inputted from the page of the document above and below or left and right and allocates to individual pages respectively, and the control section assigns a back cover page to be outputted at a last of the output sequence based on an assignment for the back cover page in the display operation section.

4. The image forming apparatus of claim 1, wherein in case arbitrary pages of the image data are assigned in the display operation section, the control section accepts an input of an image data of a new document and inserts the image data of the new document between the pages assigned.
